(19) United States
(12) Patent Application Publication
(10) Pub. No.: US 2016/0182494 A1
(43) Pub. Date: Jun. 23, 2016

(54) DISTRIBUTED DEVICE MANAGEMENT AND DIRECTORY RESOLUTION

(71) Applicant: BitTorrent, Inc., San Francisco, CA (US)

(72) Inventors: Konstantin Lissounov, Albany, CA (US); Sergey Matalytski, Minsk (BY)

(21) Appl. No.: 14/975,361

(22) Filed: Dec. 18, 2015

Related U.S. Application Data
(60) Provisional application No. 62/093,912, filed on Dec. 18, 2014.

(51) Int. Cl. H04L 29/06

(52) U.S. Cl. CPC H04L 63/0823; H04L 63/101; H04L 63/04; H04L 63/06

(57) ABSTRACT

Systems and methods for file synchronization using P2P technology are provided. In some embodiments, a method of operating a device associated with a user for enabling the sharing of a folder includes creating a Certificate Authority (CA) for the folder. The method also includes granting access to the folder to the user by creating a certificate for the user, signing the certificate for the user with a key of the CA for the folder, creating an Access Control List (ACL) for the user, and signing the ACL for the user with the key of the CA for the folder. The method also includes sharing the folder with a second device. According to some embodiments, this enables the sharing of the folder with no artificial storage limits, increased synchronization speeds, and no need to store the folder on a third-party server.

### RELATED APPLICATIONS

This application claims the benefit of provisional patent application Ser. No. 62/093,912, filed Dec. 18, 2014, the disclosure of which is hereby incorporated herein by reference in its entirety.

### FIELD OF THE DISCLOSURE

The present disclosure relates to file synchronization.

### BACKGROUND

Users interact with multiple devices depending on time and location. Because of this, accessing files or folders on one device while using a second device may be necessary. Additionally, users may want to share access to files or folders with one or more other users. This may, for example, allow for greater collaboration among the users of the shared files.

In order to provide access to files or folders to multiple devices more efficiently, a source server may replicate the files or folders to server farms that can all provide access to client devices. FIG. 1 shows a system 10 which includes a source server 12-1 (also be referred to as server 12 or servers 12). The system 10 shows the files or folders being replicated to server farms 12-2 and 12-3. Client devices are now able to access the replicated files or folders from one of the server farms 12-2 or 12-3 or the source server 12-1. Specifically, client devices 14-1 and 14-2 (also referred to as client device 14 or client devices 14) are connected to server farm 12-2 while client devices 14-3 and 14-4 are connected to server farm 12-3. The arrangement in FIG. 1 allows multiple client devices to access files or folders. However, if the files need to change, this arrangement makes it difficult to maintain the correct version.

FIG. 2 illustrates another way to arrange system 10 for sharing files or folders. In order to enable the sharing of files or folders between different devices 14 (associated with a single user or different users), the files or folders are stored on a central server 12-1 and served to each device 14 permitted to share the files or folders. If a local copy of a file is modified on one of the devices 14, this modification must be first transferred the central server 12-1. Then the modified file can be transferred to each device 14 permitted to share the modified file.

The type of arrangement in FIG. 2 is often referred to as cloud-based services because the physical location of the central server 12-1 does not matter; it could just as easily be “in the cloud.” This arrangement also includes several undesirable features. First, the files or folders are stored on the central server 12-1 that is not controlled by any of the users. This could create security and confidentiality concerns. Also, since the central server 12-1 must keep a copy of the files or folders to distribute, the provider of the central server 12-1 will cap the amount of data that may be stored and served to other devices 14.

FIG. 3 shows another problem that affects the system 10 of FIG. 1 and FIG. 2. Regardless of how the servers 12 are arranged internally, in order to serve n concurrent devices 14 at a minimum bit rate r₀, the infrastructure must be able to deliver content at an aggregate rate of n*r₀. Assuming each server 12 has fixed capacity, for large n, the number of servers 12 must be at least linear in n. Again, this leads the provider of the central server 12-1 to cap the amount of data and the number of devices 14.

Therefore, systems and methods for file synchronization are needed to deal with these complexities.

### SUMMARY

Systems and methods for file synchronization using Peer-to-Peer (P2P) technology are provided. In some embodiments, a method of operating a device associated with a user for enabling the sharing of a folder on the device where the folder contains one or more file system objects and includes a folder identification value includes creating a Certificate Authority (CA) for the folder. The method also includes granting access to the folder to the user by creating a certificate for the user including one or more keys for secure communication between peers. The peers include any device of any user that has been granted access to the folder. Granting access to the folder also includes signing the certificate for the user with a key of the CA for the folder, creating an Access Control List (ACL) for the user, and signing the ACL for the user with the key of the CA for the folder. The method also includes sharing the folder with a second device. According to some embodiments, this enables the sharing of the folder with no artificial storage limits, increased synchronization speeds, and no need to store the folder on a third-party server.

In some embodiments, the method also includes creating an ACL for the CA for the folder and signing the ACL for the CA for the folder with the key of the CA for the folder.

In some embodiments, the second device is associated with the user, and sharing the folder with the second device includes sharing the folder with the second device associated with the user by transferring the folder identification value for the folder to the second device associated with the user and communicating with one or more peers using the folder identification value to determine the contents of the folder.

In some embodiments, communicating with the peers using the folder identification value to determine the contents of the folder includes connecting with a first peer using the keys for secure communication between the peers and determining that a remote file entry object corresponding to a file system object in the folder of the first peer is different than a respective local file entry object corresponding to the file system object in the folder on the device. The method also includes, in response to determining that the remote file entry object is different than the local file entry object, comparing a timestamp associated with the remote file entry object and a timestamp associated with the local file entry object to determine which is more recently modified and, in response to determining that the remote file entry object is more recently modified, replacing the file system object in the folder with the file system object in the folder of the first peer. The method also includes, in response to determining that the local file entry object is more recently modified, replacing the file system object in the folder of the first peer with the file system object in the folder of the device.

In some embodiments, determining that the remote file entry object is different than the local file entry object includes determining that a hash tree for the folder of the first peer is different than a hash tree for the folder on the device.

In some embodiments, replacing the file system object in the folder with the file system object in the folder of the first peer also includes determining if the user associated with the first peer has permission to change the file system object. In some embodiments, determining if the first peer has permission to change the file system object includes determining if the ACL for a user associated with the change to the file system object permitted the change to the file system object.

In some embodiments, the second device is associated with a second user, and sharing the folder with the second device includes sharing the folder with the second device associated with the second user by transferring the folder identification value for the folder to the second device associated with the second user; receiving a connection from the second user including the folder identification value and a public key for the second user; granting access to the folder to the second user; and sending the certificate for the second user to the second user. Granting access to the second user includes creating a certificate for the second user including one or more keys for secure communication between the peers using the public key for the second user; signing the certificate for the second user with the key of the CA for the folder; creating an ACL for the second user; and signing the ACL for the second user with the key of the CA for the folder.

In some embodiments, the method also includes updating the ACL for the second user to change the permissions for the second user and signing the updated ACL for the second user with the key of the CA for the folder. In some embodiments, the method also includes determining that a remote file entry object corresponding to a file system object o in the folder of a device associated with the second user is more recently modified than a respective local file entry object corresponding to the file system object in the folder on the device and determining which ACL for the second user was valid at the time of the modification time of the remote file entry object. The method also includes, in response to determining that the ACL for the second user that was valid at the time of the modification time of the remote file entry object permitted the modification, replacing the file system object in the folder with the file system object in the folder of the device associated with the second user.

In some embodiments, the method also includes creating an intermediate CA using the certificate for the second user; creating an ACL for the intermediate CA; and signing the ACL for the intermediate CA with the key of the CA for the folder.

In some embodiments, transferring the folder identification value includes displaying the folder identification value to be manually read from the device to be communicated to the second device associated with the second user; displaying a QR code indicative of the folder identification value on the device to be communicated to the second device associated with the second user; and/or copying the folder identification value to a clipboard of the device to be communicated to the second device associated with the second user.

In some embodiments, the folder identification value for the folder is derived from a hash of a certificate of the CA of the folder. In some embodiments, the one or more file system objects include at least one of a file, a directory, and/or a symlink.

In some embodiments, a method of operating a second device associated with a second user for sharing a folder on a device associated with a user includes obtaining a folder identification value for the folder; transmitting to the user the folder identification value and a public key for the second user; and receiving a certificate for the second user, where the certificate for the second user includes one or more keys for secure communication between peers using the public key for the second user.

In some embodiments, the method also includes connecting with a first peer using the one or more keys for secure communication between peers and determining that a remote file entry object corresponding to a file system object in the folder of the first peer is different than a respective local file entry object corresponding to the file system object in the folder on the second device. The method also includes, in response to determining that the remote file entry object is different than the local file entry object, comparing a timestamp associated with the remote file entry object and a timestamp associated with the local file entry object to determine which is more recently modified and, in response to determining that the remote file entry object is more recently modified, replacing the file system object in the folder with the file system object in the folder of the first peer. The method also includes, in response to determining that the local file entry object is more recently modified, replacing the file system object in the folder of the first peer with the file system object in the folder of the device.

In some embodiments, replacing the file system object in the folder with the file system object in the folder of the first peer also includes determining if the user associated with the first peer has permission to change the file system object. In some embodiments, determining if the first peer has permission to change the file system object includes determining if an ACL for the user associated with the change to the file system object permitted the change to the file system object.

In some embodiments, a computer program product for operating a device associated with a user for enabling the sharing of a folder on the device where the folder contains one or more file system objects and includes a folder identification value. The computer program product has a non-transitory computer-readable storage medium having computer program instructions for creating a CA for the folder. The computer program instructions are also for granting access to the folder to the user by creating a certificate for the user including one or more keys for secure communication between peers. The peers include any device of any user that has been granted access to the folder. Granting access to the folder also includes signing the certificate for the user with a key of the CA for the folder, creating an ACL for the user, and signing the ACL for the user with the key of the CA for the folder. The computer program instructions are also for sharing the folder with a second device.

In some embodiments, a device associated with a user includes a folder to be shared; a communication interface configured to communicatively couple the device to one or more peers; and circuitry. The circuitry is configured to: create a CA for the folder; grant access to the folder to the user; and share the folder with a second device. Granting access includes being configured to create a certificate for the user including one or more keys for secure communication between peers, where the peers include any device of any user that has been granted access to the folder; sign the certificate for the user with a key of the CA for the folder; create an ACL for the user; and sign the ACL for the user with the key of the CA for the folder.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates an example system for serving files or folders.

FIG. 2 illustrates another example system for serving files or folders.

FIG. 3 illustrates an exemplary bandwidth requirement for the system of FIG. 1 or FIG. 2.

FIG. 4 illustrates an example system for serving files or folders using Peer-to-Peer (P2P) technology, according to some embodiments of the present disclosure.

FIG. 5 illustrates a method of operating a device associated with a user for enabling the sharing of a folder on the device, according to some embodiments of the present disclosure.

FIG. 6 illustrates additional details for granting access to the folder, according to some embodiments of the present disclosure.

FIG. 7 illustrates a flowchart for creating a shared folder on a device of a user and sharing the folder with a second device associated with the same user, according to some embodiments of the present disclosure.

FIG. 8 illustrates a flowchart for creating a shared folder on a device of a user and sharing the folder with a second device associated with second user, according to some embodiments of the present disclosure.

FIG. 9 illustrates a flowchart for updating the access permissions of a second user, according to some embodiments of the present disclosure.

FIG. 10 illustrates a flowchart for providing a second user with administrative permissions, according to some embodiments of the present disclosure.

FIG. 11 illustrates a flowchart for comparing file entry objects between a user and a second user, according to some embodiments of the present disclosure.

FIG. 12 illustrates a flowchart for updating an Access Control List (ACL), according to some embodiments of the present disclosure.

FIG. 13 illustrates a system for transmitting files using P2P technology, according to some embodiments of the present disclosure.

FIG. 14 illustrates a flowchart for transmitting files using P2P technology in order to synchronize the shared folder, according to some embodiments of the present disclosure.

FIG. 15 is a block diagram of a device for sharing a folder, according to some other embodiments of the present disclosure.

FIG. 16 is a block diagram of a device for sharing a folder with modules according to some embodiments of the present disclosure.

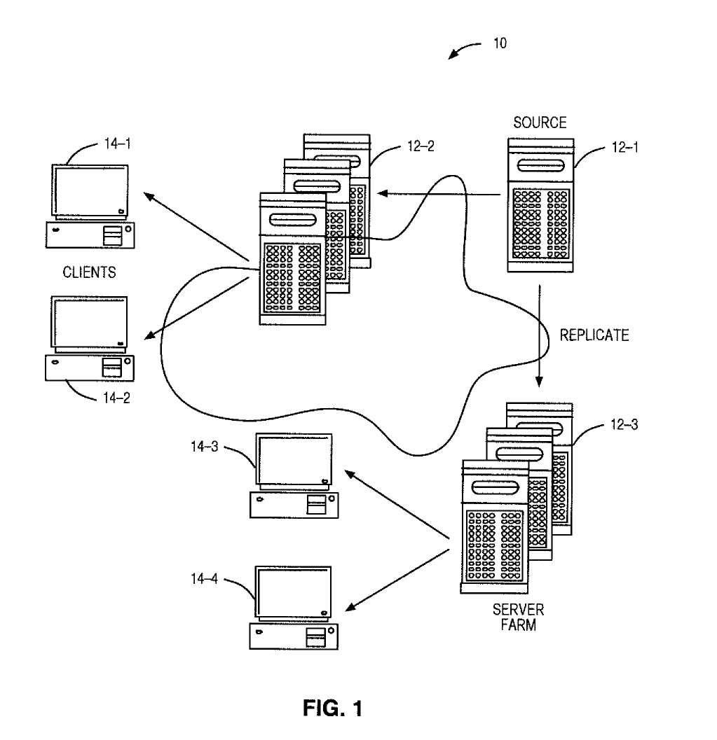

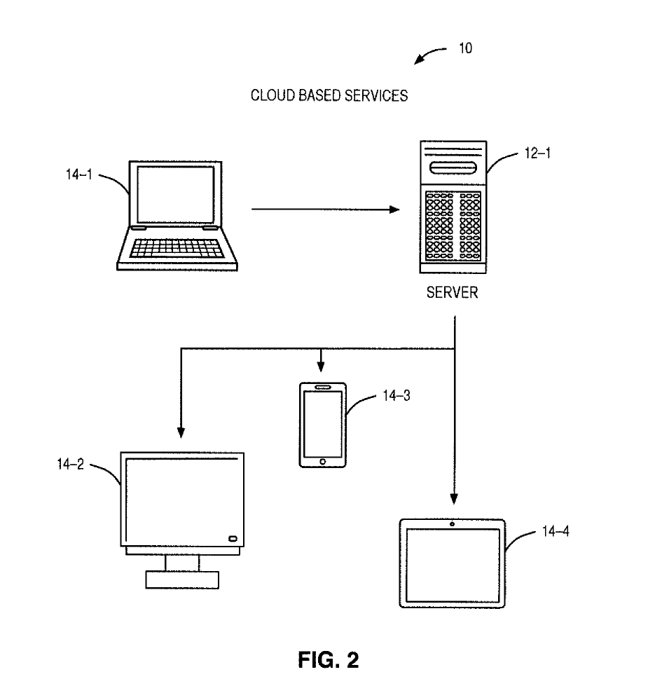

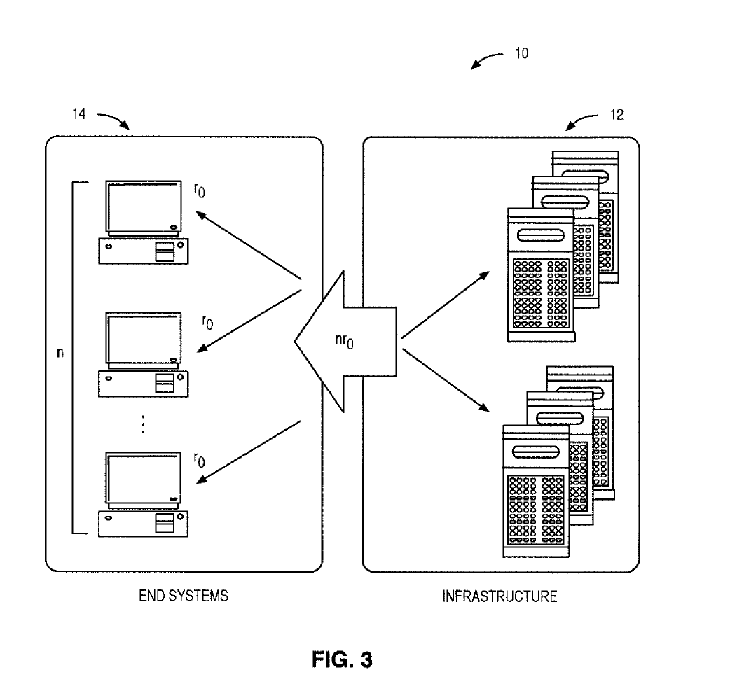

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Systems and methods for file synchronization using Peer-to-Peer (P2P) technology are provided. In some embodiments, a method of operating a device associated with a user for enabling the sharing of a folder on the device where the folder contains one or more file system objects and includes a folder identification value includes creating a Certificate Authority (CA) for the folder. The method also includes granting access to the folder to the user by creating a certificate for the user including one or more keys for secure communication between peers. The peers include any device of any user that has been granted access to the folder. Granting access to the folder also includes signing the certificate for the user with a key of the CA for the folder, creating an Access Control List (ACL) for the user, and signing the ACL for the user with the key of the CA for the folder. The method also includes sharing the folder with a second device. According to some embodiments, this enables the sharing of the folder with no artificial storage limits, increased synchronization speeds, and no need to store the folder on a third-party server.

In some embodiments, a certificate-based identity and authentication system is used for designating folder ownership, changing of folder permissions at any time, and revoking of future access to folder changes. This system is 100% cryptographic with no user-created passwords involved. A certificate is tied to a user and becomes the user's private identity. A user's devices can be associated with each other using this identity/certificate. This allows for folder connections and application settings to be synchronized across the user's devices. When two or more devices are associated with a user's certificate, folders added to one device are automatically added to the other devices, and the folders are synchronized across the devices. Hence, if the contents of a folder in one device change, the same changes are made to the folder on the other devices.

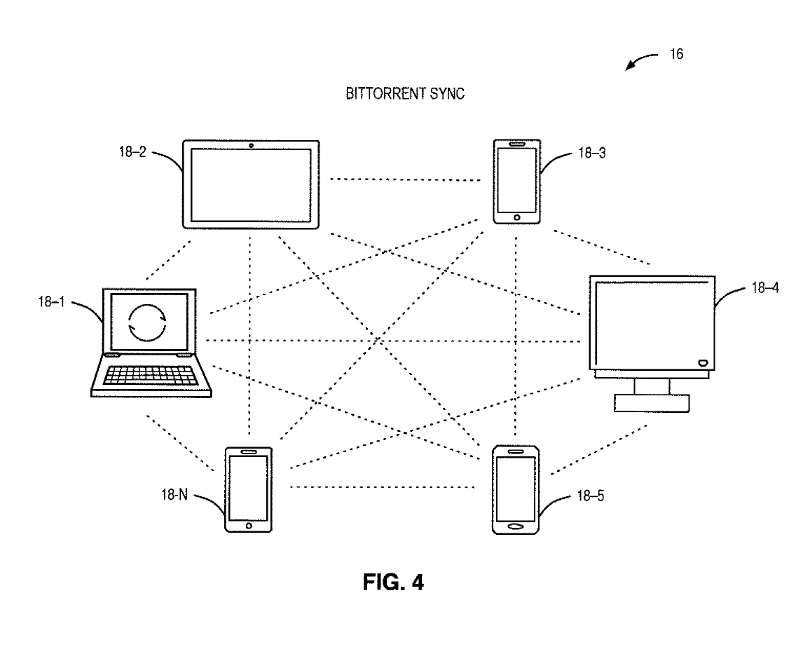

FIG. 4 illustrates an example system 16 for serving files or folders using Peer-to-Peer (P2P) technology, according to some embodiments of the present disclosure. As shown, FIG. 4 includes multiple client devices 18-1 through 18-N (referred to herein as device 18 or devices 18). In this embodiment, each device 18 is able to communicate with each other device 18 across some network. This example system 16 is also sometimes referred to herein as BitTorrent Sync or just Sync. This system 16 may be used for file synchronization between two or more devices 18. Also, as used herein, the term “peer” refers to another device 18 that has been granted access to a file or folder under discussion.

Also, each device 18 has at least one user associated with the device 18. In some embodiments discussed herein involving more than one device 18, there is no difference whether the same user is associated with the more than one device 18 or if different users are associated with the more than one device 18. In instances where this distinction does make a difference, that is noted.

As shown in FIG. 4, each of the devices 18 may be different types of devices such as a desktop computer, a laptop computer, a tablet computer, a smartphone, etc. Additionally, there is no need for the devices 18 to be using the same operating system or to be on the same network. Each device 18 that is configured to perform one or more of the methods described herein may be used.

In some embodiments, association between devices 18 is accomplished by creating hidden folder (sometimes referred to as a Sync shared folder) which is synced between all user devices 18. This hidden folder is used to exchange a list of shared folders available to the user, as well as all necessary cryptographic objects (keys, certificates, ACLs) required to access the shared folders. As a result, when the user adds a new synchronized folder on a device 18 associated with the user, this new folder becomes immediately available on all other user devices 18. In some embodiments, the hidden folder has a unique randomly generated key (e.g., a 20 byte key). In some embodiments, the key may be entered on another device for adding the shared folder to that device. After the key is entered on a device 18 of the user, the device 18 may use the key as a seed to generate a set of cryptographic keys to use with the folder (e.g., a ED25519 set of keys).

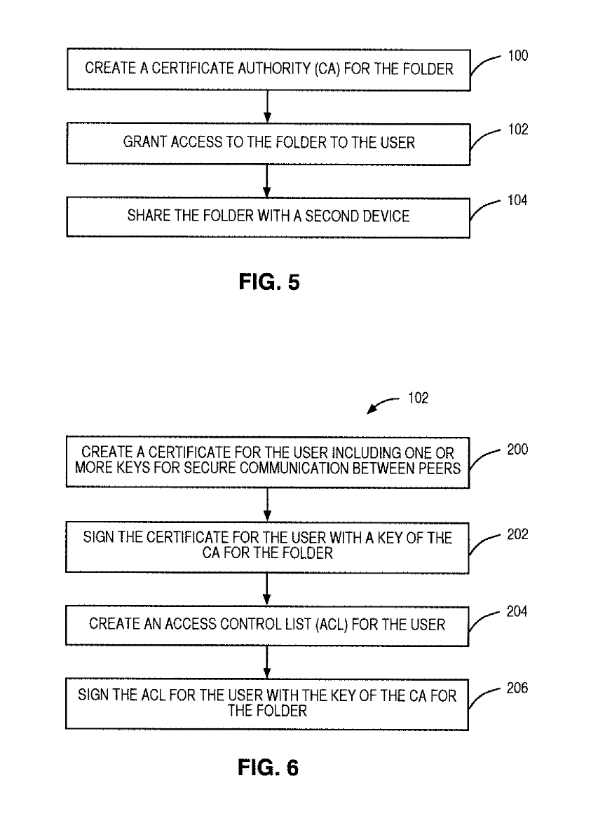

FIG. 5 illustrates a method of operating a device 18 associated with a user for enabling the sharing of a folder on the device 18, according to some embodiments of the present disclosure. First, the device 18 creates a CA for the folder (step 100). In some embodiments, this is accomplished by User A creating a CA for the folder by self-signing User A's Rivest-Shamir-Adleman (RSA) CA key and creating an X509 root authority certificate. In some embodiments, the device 18 also creates an ACL object for the CA. The ACL object for CA may include one or more of the following:
CA certificate
current state (can sign/cannot sign)
timestamp

Then, the device 18 grants access to the folder to the user (step 102). This step will be discussed in more detail in relation to the next figure. Finally, the device 18 shares the folder with a second device 18 (step 104). In some embodiments, this is accomplished by transferring a folder identification value (sometimes referred to as FOLDER_ID) for the folder to the second device 18. In some embodiments, this folder identification value is a hash of the CA root certificate and more particularly may be equal to SHA1(SHA1(ED25519 public key)) where SHA1 is Secure Hash Algorithm 1. In some embodiments, this folder identification value can be used to find other peers who also have access to the folder.

In some embodiments, the folder identification value (or some value that can be used to determine it) can be transferred to other devices 18 using one or more of the following methods: (1) the folder identification value is manually read from one device 18 and typed into another device 18; (2) a mobile device (or any other device capable of capturing an image) scans a Quick Reference (QR) code on one device 18 and then transmits the folder identification value to another device 18 by scanning another QR code; and/or (3) the folder identification value is copied to the operating system clipboard of a device 18 and transferred to another device 18 through a communication message, such as using email, instant messaging, etc.

The user associated with this second device 18 may be the same user associated with the device 18 that is sharing the folder. For example, this could correspond to a user desiring to have a shared folder on both a home computer and a work computer where the files are synchronized between the devices. Or, the user associated with this second device 18 may be different than the user associated with the device 18 that is sharing the folder. For example, this could correspond to a user desiring to have a shared folder on a computer that can also be accessed by a friend or colleague where the files are synchronized between the devices.

FIG. 6 illustrates additional details for granting access to the folder as discussed above in relation to step 102, according to some embodiments of the present disclosure. First, the device 18 creates a certificate for the user including one or more keys for secure communication between peers (step 200). The device then signs the certificate for the user with a key of the CA for the folder (step 202). The device 18 then creates an ACL for the user (step 204) and signs the ACL for the user with the key of the CA for the folder (step 206). More details regarding specific embodiments will be discussed below. The ACL object for the user may include one or more of the following:
user name visible to all peers
user public key (e.g., a ED25519 public key) to verify file changes made by this user
access permissions (rw, ro, no access)
timestamp

In some embodiments, the ACL object for user permissions is not included in the user Secure Sockets Layer (SSL) certificate for the following reasons. The certificate is used for SSL only to connect to other peers in the swarm. It is not to be changed dynamically, while the ACL object on the other hand may be updated (e.g., changed user name, changed permissions, etc.). Also, during an SSL handshake, the SSL certificate is sent in plain text and therefore the ACL object for the user would also be in plain text.

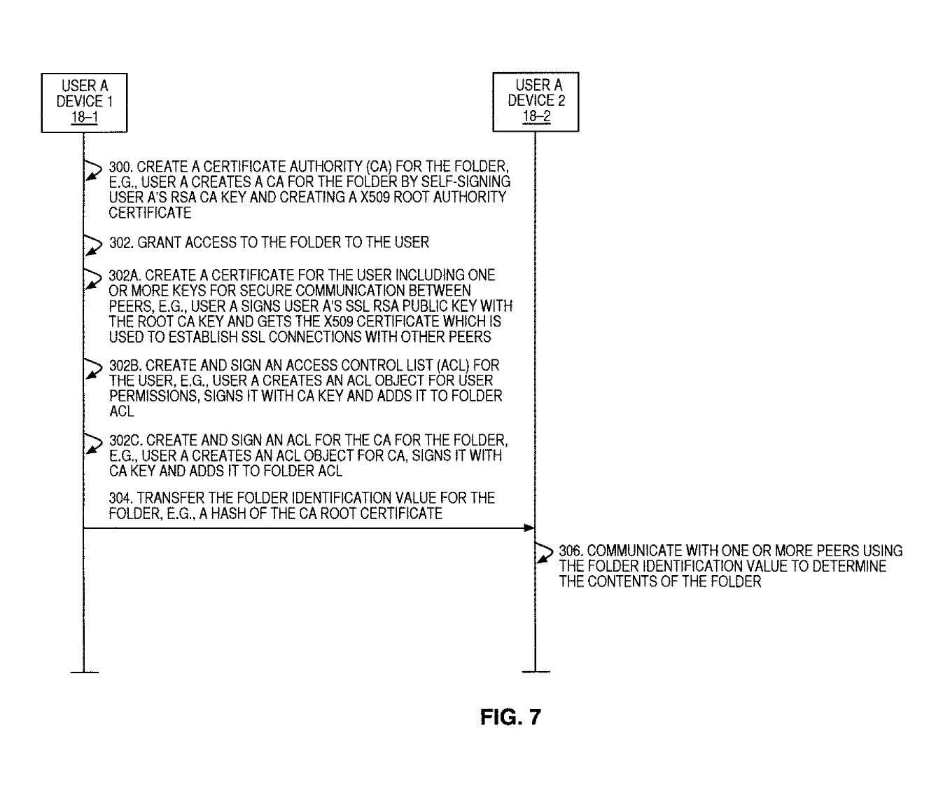

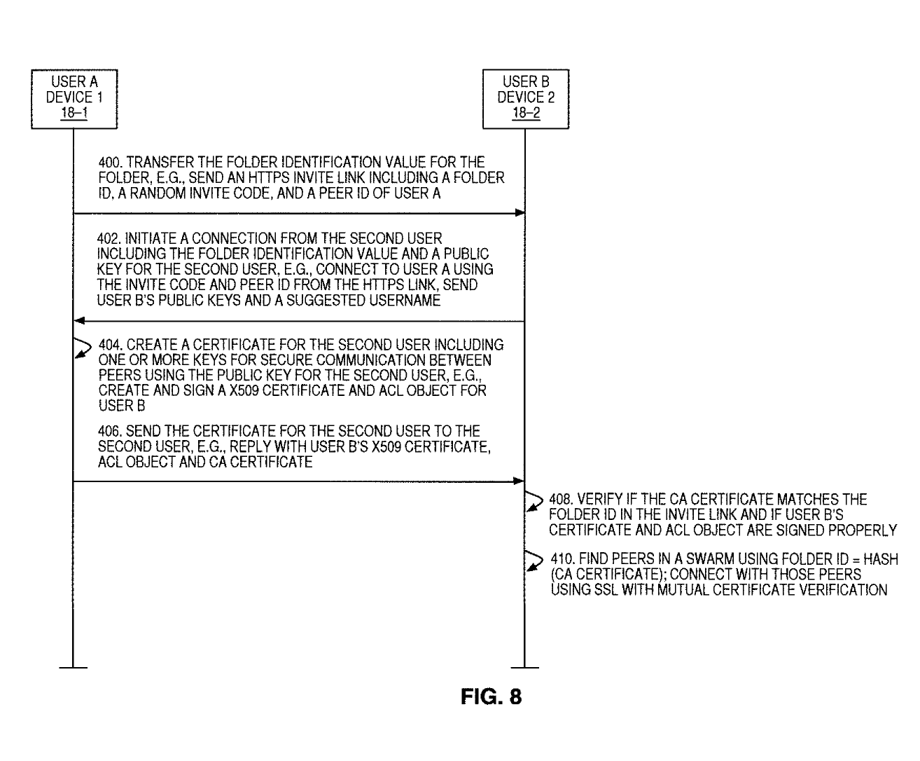

Step 104 discusses sharing the folder with a second device 18. As discussed above, the user of this second device 18 may or may not be the same user that is associated with the device 18 that is sharing the folder. However, in some embodiments, the steps involved with sharing the folder with the second device 18 are different in these two cases. Therefore, FIG. 7 illustrates a flowchart for creating a shared folder on a device 18-1 of a user and sharing the folder with a second device 18-2 associated with the same user while FIG. 8 illustrates a flowchart for creating a shared folder on a device 18-1 of a user and sharing the folder with a second device 18-2 associated with second user, according to some embodiments of the present disclosure.

In FIG. 7, both the first device 18-1 and the second device 18-2 are labeled as “User A” to indicate that both devices 18 are associated with the same user. First the device 18-1 creates a CA for the folder (step 300). In some embodiments, this is accomplished by User A creating a CA for the folder by self-signing User A's RSA CA key and creating an X509 root authority certificate. Then the device 18-1 grants access to the folder to the user (step 302). This may involve creating a certificate for the user including one or more keys for secure communication between peers, e.g., User A signs User A's Secure Socket Layer (SSL) RSA public key with the root CA key and gets the X509 certificate which is used to establish SSL connections with other peers (step 302A). In some embodiments, every user has three key pairs: an RSA key pair to be used in SSL connections, an RSA key pair to be used for folder CA (root or intermediate), and an ED25519 key pair used to sign file changes made by the user.

Then the device 18-1 creates and signs an ACL for the user, e.g., User A creates an ACL object for user permissions, signs it with the CA key, and adds it to folder ACL (step 302B). The device 18-1 may then create and sign an ACL for the CA for the folder, e.g., User A creates an ACL object for CA, signs it with CA key, and adds it to folder ACL (step 302C). At this point, the folder is ready to be shared.

The device 18-1 then transfers the folder identification value for the folder, e.g., a hash of the CA root certificate to the second device 18-2 (step 304). This transfer may occur in any way, several of which are discussed above. The second device 18-2 may now communicate with one or more peers using the folder identification value to determine the contents of the folder (step 306). Some embodiments of how this is accomplished are discussed below.

In FIG. 8, the first device 18-1 is labeled as “User A” and the second device 18-2 is labeled as “User B” to indicate that the two devices 18 are associated with different users. Also, it is assumed that the steps of preparing the folder for sharing have already occurred. For instance, steps 300 through 302C may have already occurred. In this way, the folder is ready to be shared. While this example uses User A as the first user, this user does not necessarily need to be the user who originally shared the folder. More details on some embodiments for how a user may gain administrative permissions are discussed below.

Device 18-1 transfers the folder identification value for the folder to the second device 18-2, e.g., sends a Hypertext Transfer Protocol with SSL (HTTPS) invite link including a FOLDER_ID, a random invite code, and a peer ID of User A (step 400). The second device 18-2 may now initiate a connection to the device 18-1 including the folder identification value and a public key for the second user, e.g., connect to User A using the invite code and peer ID from the HTTPS link, send User B's public keys and a suggested username (step 402). This two-way handshake allows the two devices 18 to know that the other device is the correct device and is responding to the correct information, according to some embodiments.

If the device 18-1 is satisfied that the information received is correct (e.g., the invite code is still valid), then the device 18-1 can proceed to give the user associated with the second device 18-2 access. This is done by the device 18-1 creating a certificate for the second user including one or more keys for secure communication between peers using the public key for the second user, e.g., creating, and signing an X509 certificate and ACL object for User B (step 404). The certificate for the second user is then sent to the second user, e.g., reply with User B's X509 certificate, ACL object and CA certificate (step 406).

After receipt of the certificate, the second device 18-2 may verify if the CA certificate matches the FOLDER_ID in the invite link and if User B's certificate and ACL object are signed properly (step 408). The second device 18-2 may then find peers in a swarm using FOLDER_ID=hash (CA certificate) and connect with those peers using SSL with mutual certificate verification (step 410). The additional steps of how the folders and files are then synchronized between the devices 18 are discussed in more detail below.

In the example discussed in relation to FIG. 8, User A grants certain permissions to User B in regards to the folder. This is accomplished by including the correct information in the user ACL. Permissions granted to User B and other peers are stored in an ACL. An ACL is created for every shared folder, and it syncs between devices in the same way as a files tree (discussed in more detail below). In some embodiments, every user has as ED25519 key pair which is used to sign file changes made by a given user to a file. A public key for the user is included in an ACL object and synced between all peers. Every ACL object is signed by the initial owner of the folder (or intermediate owners) with an authority certificate. A root authority certificate is known by all the peers, so every peer can verify signature of ACL objects.

In some embodiments, if User B wants to access the folder from multiple devices 18, User B needs to transfer User B's certificate/private key between the devices 18. If User B wants to access multiple folders, User B reuses User B's key pairs, but needs to have different CA and access certificates for the different folders. If User A wants to share multiple folders with User B, User A will be able to see if the RSA public key in the access request is known and was approved/denied before (i.e., User A does not need to verify the public key twice).

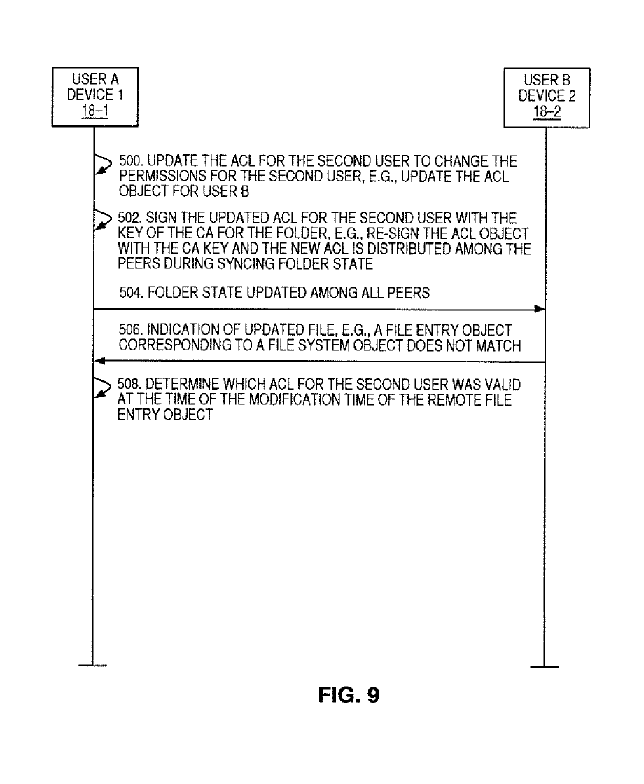

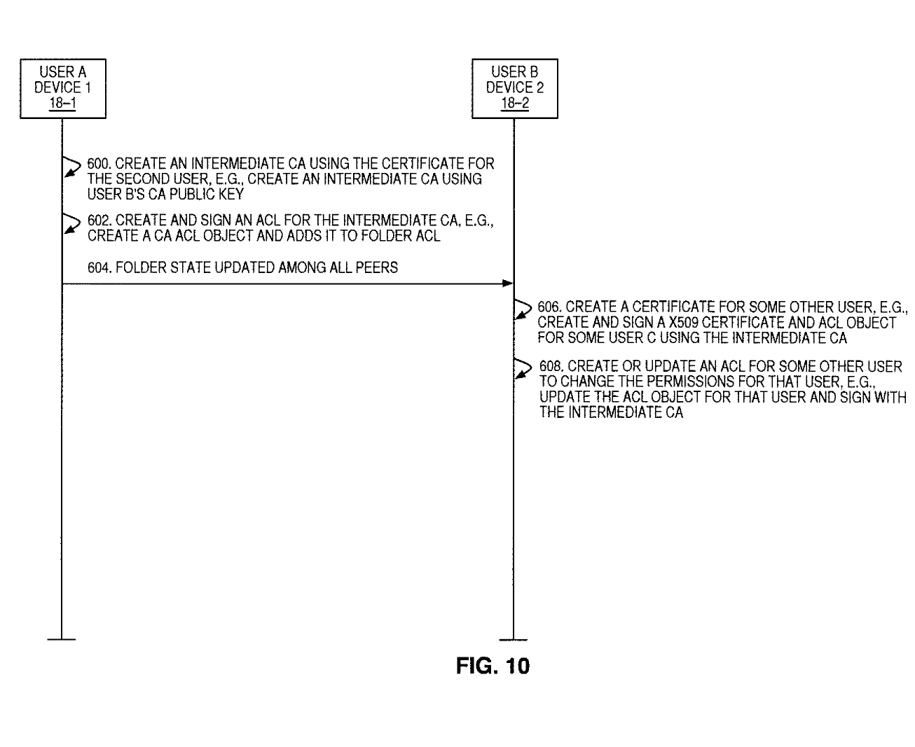

In some instances, User A may want to change the permissions assigned to User B or to provide User B with administrative permissions. These two tasks are discussed in relation to FIGS. 9 and 10, respectively. FIG. 9 illustrates a flowchart for updating the access permissions of a second user, according to some embodiments of the present disclosure. The device 18-1 updates the ACL for the second user to change the permissions for the second user, e.g., update the ACL object for User B (step 500). This might include assigning the second user with read-only access, or with full read-write access, for example. The device 18-1 then signs the updated ACL for the second user with the key of the CA for the folder, e.g., re-signs the ACL object with the CA key and the new ACL is distributed among the peers during syncing folder state (step 502).

At some later time, the folder state is updated among all peers (step 504). Some ways of accomplishing this are discussed in more detail below. Also at some later time, the device 18-1 may receive an indication of an updated file, e.g., a file entry object corresponding to a file system object does not match (step 506). If this update was performed by the second user, the device 18-1 will determine which ACL for the second user was valid at the time of the modification time of the remote file entry object (step 508). For instance, the second user may no longer be permitted to change the file. However, if at the time of the file modification, the ACL for the second user did permit the change, then the device 18-1 should accept this updated file.

FIG. 10 illustrates a flowchart for providing a second user with administrative permissions, according to some embodiments of the present disclosure. The device 18-1 creates an intermediate CA using the certificate for the second user, e.g., creates an intermediate CA using User B's CA public key (step 600). The device 18-1 then creates and signs an ACL for the intermediate CA, e.g., creates a CA ACL object and adds it to folder ACL (step 602). The folder state is updated among all peers (step 604). At this point, any peer with this updated information would be able to verify that an item signed by the second user's intermediate CA received its authority from the CA for the folder.

The second user can now create a certificate for some other user, e.g., create and sign an X509 certificate and ACL object for some user C using the intermediate CA (step 604). The second user can also create or update an ACL for some other user to change the permissions for that user, e.g., update the ACL object for that user, and sign with the intermediate CA (step 606). In some embodiments, any folder admin can revoke admin privileges from other users (including root CA) by modifying CA objects in the folder ACL. In other embodiments, this may be restricted or configurable.

In some embodiments, Sync offers different modes to manage device capacity. A folder can be available for connection on a device 18 (Available Mode), connected with the files available for on-demand consumption (Connected Mode), or fully synchronized (Full Sync Mode).

In Available Mode, the folder is listed but no content is synchronized across devices 18. This requires the least amount of storage capacity on that device 18, and the least amount of access to the files.

In Connected Mode, instead of creating a local copy of every file in a shared folder, Sync creates zero-sized stub files with the same name as the original file and with an added extension or suffix (e.g., “.bts”). Additionally, Sync may register itself as the handler for the “.bts” file type if permitted by the operating system of the device 18. In this case, when a user selects to open the stub file, the operating system of the device 18 tells Sync to handle the open request. In response, Sync may start downloading the file associated with the selected stub file to a local drive of the device from other associated devices 18 as discussed below. When download is completed, Sync removes the extension or suffix from file and opens the file for the user using a default application associated with a file type of the file.

In Full Sync Mode, each of the associated devices 18 keeps a local copy of every file in the shared folder and the files are synchronized. Without loss of generality, the discussion below assumes a device 18 that is operating in Full Sync Mode. However, the same processes could be applied synchronize the correct information in the other modes.

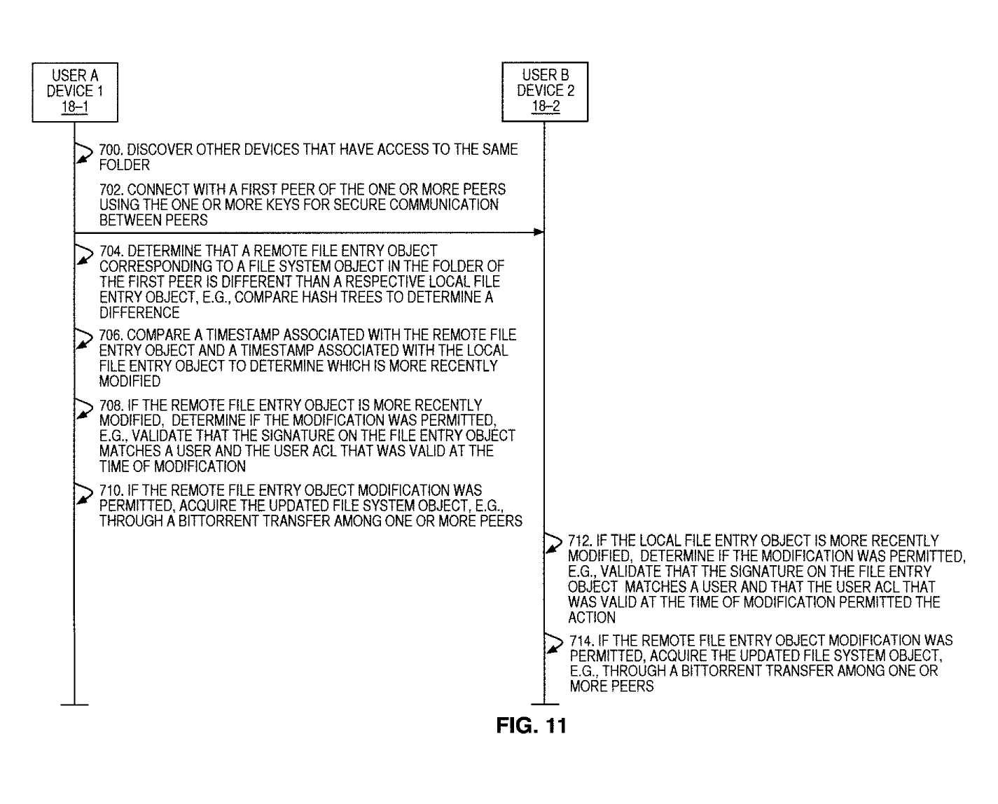

In order to keep the files and settings synchronized between the various devices 18, two or more devices 18 interact to determine the current state of the shared folder. In some of the following examples, only two devices 18 are discussed. However, in some embodiments, there will be more than two and perhaps much more than two devices 18 that are exchanging information between each other. FIG. 11 illustrates a flowchart for comparing file entry objects between two devices 18, according to some embodiments of the present disclosure. In this example, the two devices 18 are associated with different users. However, this method is not limited thereto.

The device 18-1 discovers other devices 18 that have access to the same folder (step 700). In this example, the device 18-1 discovers device 18-2 as a first peer. This process would still apply even if the discovery step worked in the other direction. That is, if the roles are reversed, at least most of the steps still apply.

The device 18-1 connects with a first peer of the one or more peers using the one or more keys for secure communication between peers (step 702). After some exchange indicative of the current state of the folder, the device 18-1 determines that a remote file entry object corresponding to a file system object in the folder of the first peer is different than a respective local file entry object, e.g., compares hash trees to determine a difference (step 704).

In some embodiments, determining that the remote file entry object is different is accomplished by using a tree such as a hash tree to represent the files in the folder. For each folder that has been added to Sync, Sync creates a tree representing the folder's structure and its contents. Sync then compares trees across devices 18 containing the same folder to determine what needs to be sent and received to each device 18 so the folders become synchronized.

In some embodiments, Sync uses its distributed security mechanism to discover other devices 18 that have access to the same folder. When any number of those devices 18 are discovered, trees are compared and data moves in either direction to synchronize the folders. This may occur simultaneously with multiple devices 18 at the same time. In some embodiments, tree comparisons are triggered on local file system notifications to detect what needs to be sent or received.

If a device 18 has read/write permissions, it both sends and receives files to get folders across any number of devices 18 synchronized. If a device 18 has read-only permissions, it only receives updates from other devices 18 and will not update other devices 18.

In this way, Sync uses a distributed file system to keep the same set of files synchronized across any number or peers, or devices 18. This distributed system functions without any central server, so peers work out common understanding of the tree state based on some rules. The system also has special rules to resolve conflicts between peers. The, system also works if a peer has partial information about a modified file or directory structure.

In some embodiments, the system also includes a method to optimize the comparison of file trees and detecting changes. For every file system object (file, directory, symlink, etc.) in a shared folder, Sync creates an internal file entry object, which includes some or all of the following information:
filesystem name
timestamp when current structure was added/updated into Sync
user and device ID where object was created/updated
file state (exists/removed)
file type
hash of file content (if any)
modification time, size, symlink content, other attributes which need to be synced between devices
hash of entire file entry object
signature (signed hash of file entry object)
   In some embodiments, all file entry objects are joined into a hash tree. The in-memory tree has the same structure as the file system tree in the shared folder. Every tree node has an associated hash value which is calculated in the following way: a tree node hash=hash (hash of the file entry object corresponding to current node+hashes of child nodes). Hash of the root node is considered as a root hash of the current shared folder.

Whenever any file object is changed in a shared folder, the root hash is changed as well (since it depends on hashes of all child objects). When a new peer connects, the peers exchange root hashes of the tree. Depending on the result, Sync detects nodes that are different. This triggers a merge process, as discussed below.

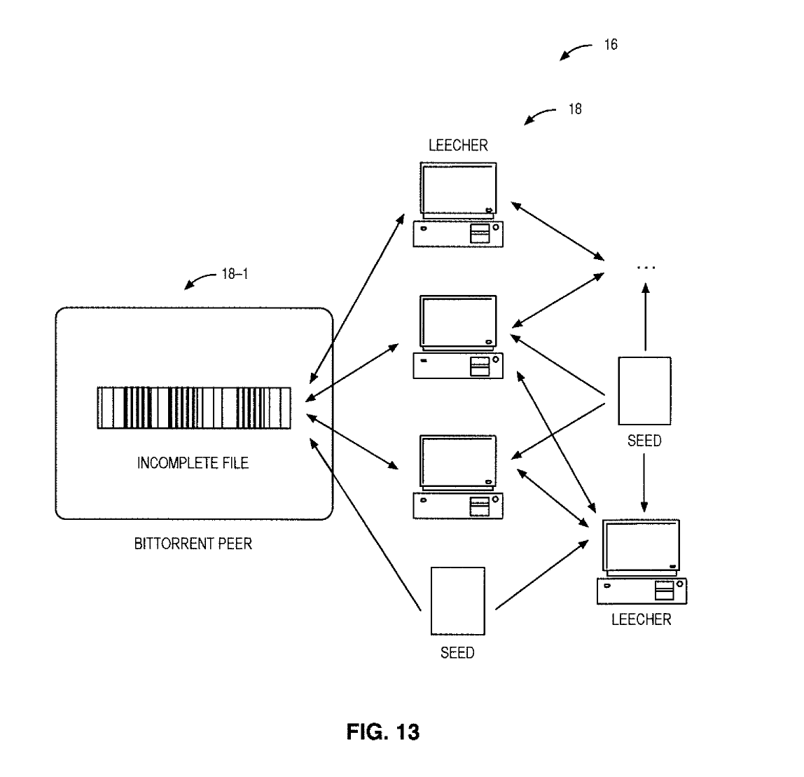

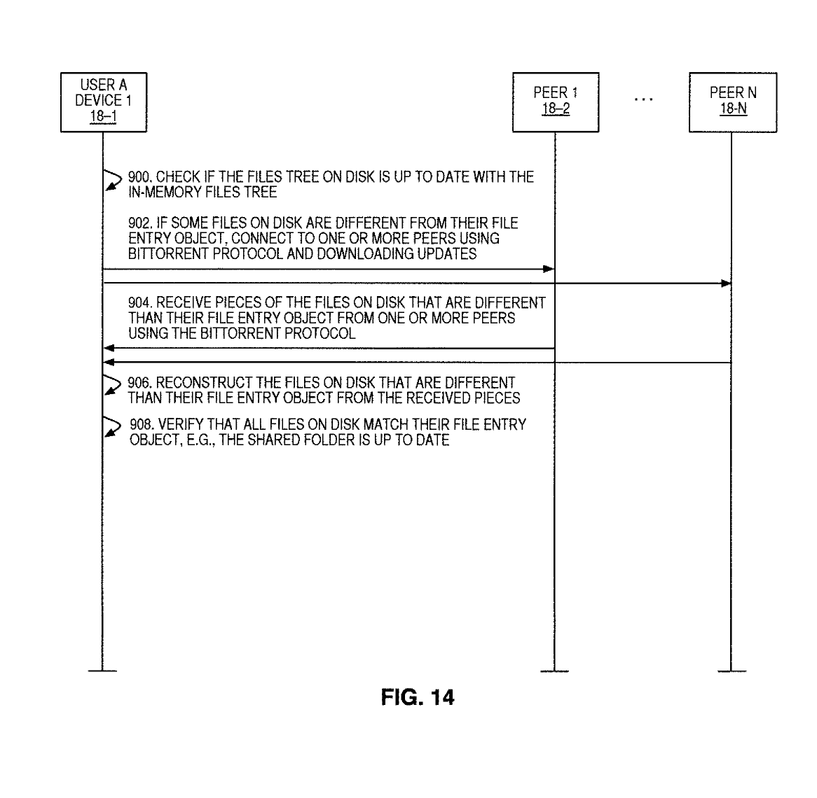

Returning to FIG. 11, after determining that there is a difference between the two peers, the device 18-1 compares a timestamp associated with the remote file entry object and a timestamp associated with the local file entry object to determine which is more recently modified (step 706). If the remote file entry object is more recently modified, the device 18-1 determines if the modification was permitted, e.g., validate that the signature on the file entry object matches a user and that the user ACL that was valid at the time of modification permitted the action (step 708). If the remote file entry object modification was permitted, acquire the updated file system object, e.g., through a BitTorrent transfer among one or more peers (step 710). Additional details related to this type of transfer are provided below in reference to FIGS. 13 and 14.

Depending on the implementation, the peer device may be performing a similar comparison of the information. If the second device 18-2 determines that the local file entry object (on the device 18-1) is more recently modified, the second device 18-2 determines if the modification was permitted, e.g., validates that the signature on the file entry object matches a user and that the user ACL that was valid at the time of modification permitted the action (step 712). If the remote file entry object (from the perspective of the second device 18-2) modification was permitted, acquire the updated file system object, e.g., through a BitTorrent transfer among one or more peers (step 714).

In this way, the two devices 18 can determine the most up to date version of every file and transfer the necessary data. Again, although only two devices 18 are shown in these examples for simplicity, there can be any number of devices 18 exchanging information with each other or some subset of each other.

One special circumstance that might occur relates to deleted files. For instance, if a user is permitted to delete a file, this deletion should be carried over to other devices 18 as well. In order to prevent a later device 18 from treating this as a new file, in some embodiments, when a file system object is removed from a shared folder, Sync keeps the file entry object in tree and sets its state to removed. The file entry state is included into the root hash, and it triggers tree sync operations between peers connected to the shared folder. When a peer receives and accepts a file entry object from a remote peer, and the file state is set to removed, it removes the local file as well.

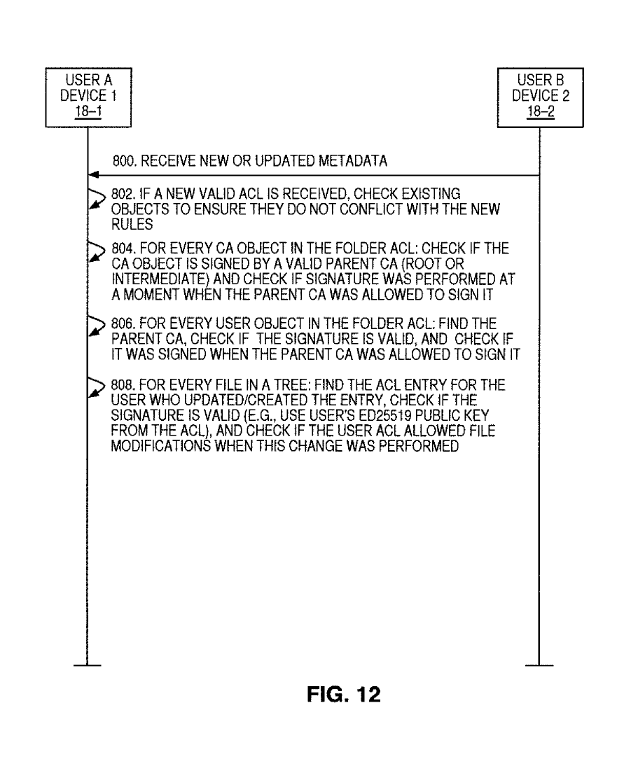

The previous figure related to updating the contents of the files and folders. At several steps, the devices 18 should check various ACLs to determine if modifications were permitted, for example. Because of this, in some embodiments, the ACLs between two or more peers should be updated before any other changes are made. FIG. 12 illustrates a flowchart for updating an ACL, according to some embodiments of the present disclosure.

Again, FIG. 12 depicts the two devices 18 as being associated with two different users, although this flowchart and this disclosure are not limited thereto. The device 18-1 first receives new or updated metadata (step 800). As used herein, this metadata may include any information about the files and folders that are being shared. Specifically, in this example, the ACLs for the CAs and users may be included in this metadata. In some embodiments, if an ACL object is updated, a history of the previous states of the ACL object is maintained. Therefore, it is always possible to verify if actions were performed while the ACL was valid for a given user or CA.

If a new valid ACL is received, the device 18-1 checks existing objects to ensure they do not conflict with the new rules (step 802). Specifically, this check may include the following:

For every CA object in the folder ACL: the device 18-1 checks if the CA object is signed by valid parent CA (root or intermediate) and checks if signature was performed at a moment when the parent CA was allowed to sign it (step 804). If a CA object fails this validation, that object can be removed. Also, any additional objects relying on this CA object for validation will also fail.

For every user object in the folder ACL: the device 18-1 finds the parent CA, checks if the signature is valid, and checks if it was signed when the parent CA was allowed to sign it (step 806). If a user object fails this validation, that object can be removed. Also, any additional objects relying on this user object for validation, such as a modification made by that user, will also fail.

For every file in a tree: the device 18-1 finds the ACL entry for the user who updated/created the entry, checks if the signature is valid (e.g., uses user's ED25519 public key from the ACL), and checks if the user ACL allowed file modifications when this change was performed (step 808). This step is either similar or the same as the validation performed in some of the steps discussed in the previous figure.

The previous figures relate to determining which files should be updated and ensuring that those updates were authorized. When it is determined that a new version of a file is needed, the device 18-1 could get this file in any suitable way. One such way is to use the BitTorrent protocol, or some other P2P technology, to get the file from other devices 18 that have the updated version (e.g., peers). Using such a technique allows the system to work without the use of a central server, as discussed above.

FIG. 13 illustrates a system for transmitting files using P2P technology, according to some embodiments of the present disclosure. The device 18-1 has determined that a file needs to be updated, perhaps using any of the techniques described above. In FIG. 13, the device 18-1 is labeled as the “BitTorrent Peer,” and the other devices 18 are labeled as the “BitTorrent Network.” As shown, device 18-1 includes an incomplete version of the file (perhaps starting with no parts of the file). Also as shown, the peers in the BitTorrent Network can be either seeds or leechers. A seed is a peer that has the complete file and is sharing pieces of it. A leecher is a peer that does not have the complete file and is therefore accepting pieces as well as possibly sharing some pieces.

According to some P2P technologies, such as the BitTorrent protocol, the device 18-1 may receive pieces from one or more peers at the same time. Also, if there is another peer that needs to complete the file, the device 18-1 may transfer pieces of the file to those peers, if possible, even before a complete copy of the file has been acquired. Using such a technology, the file does not need to be located on a central server. Also, instead of additional users potentially slowing the transfer speeds as in a central server based system, additional users may provide increased transfer speeds as pieces may arrive from different peers in different networks.

FIG. 14 illustrates a flowchart for transmitting files using P2P technology in order to synchronize the shared folder, according to some embodiments of the present disclosure. In this figure, only the device 18-1 is considered for receiving the files for simplicity. However, in practice, the peers may have files or pieces of files that the device 18-1 is also able to provide.

The device 18-1 checks if the files tree on disk is up to date with the in-memory files tree (step 900). This may be accomplished using any method discussed herein, or any other suitable way. If some files on disk are different from their file entry object, the device 18-1 connects to one or more peers using the BitTorrent protocol and downloads updates (step 902). The device 18-1 receives pieces of the files on disk that are different than their file entry object from one or more peers (devices 18-2 through 18-N) using the BitTorrent protocol (step 904). Once all of the pieces for a file are received, the device 18-1 reconstructs the files on disk that are different than their file entry object from the received pieces (step 906). When all files are reconstructed, the device 18-1 can verify that all files on disk match their file entry object, e.g., the shared folder is up to date (step 908). In embodiments that use a hash tree to represent the files tree, this may be accomplished by generating all of the hashes that need to change. Eventually, a new root hash for the folder will be generated and can be compared to the root hash obtained in other steps.

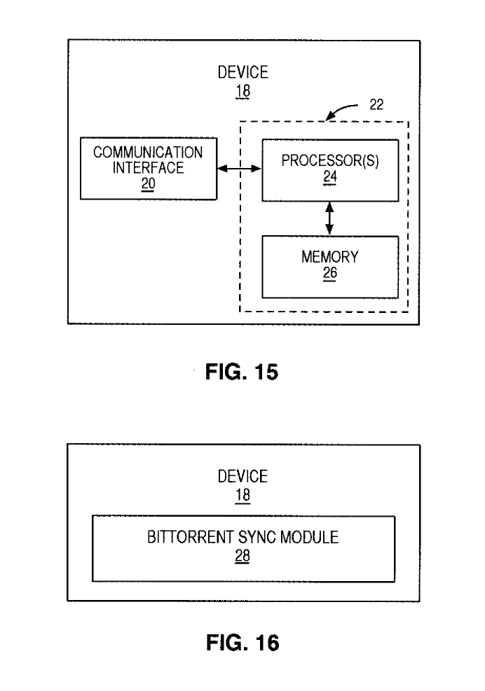

FIG. 15 is a block diagram of a device 18 for sharing a folder, according to some other embodiments of the present disclosure. The device 18 includes a communication interface 20 for communication with other devices 18. The device 18 also includes circuitry 22 that includes one or more processors 24 which may be one or more Central Processing Units (CPUs) for performing any of the processes described herein. Circuitry 22 also includes a memory 26 (e.g. non-volatile and/or volatile memory, such as hard drive, flash memory, memory stick and the like). Also, volatile memory may include random access memory and others known in the art. Memory 26 may store program instructions such as those to perform the functionality described herein.

In some embodiments, a carrier containing the aforementioned program instructions is provided. The carrier is one of an electronic signal, an optical signal, a radio signal, or a computer readable storage medium (e.g., a non-transitory computer readable medium).

FIG. 16 is a block diagram of a device 18 for sharing a folder with modules according to some embodiments of the present disclosure. The BitTorrent Sync module 28 is implemented in software that, when executed by a processor of device 18, causes the device 18 to operate according to one of the embodiments described herein.

The following acronyms are used throughout this disclosure.
ACL Access Control List
CA Certificate Authority
CPU Central Processing Unit
HTTPS Hypertext Transfer Protocol with SSL
P2P Peer-to-Peer
QR Quick Reference
RSA Rivest-Shamir-Adleman
SHA1 Secure Hash Algorithm 1
SSL Secure Sockets Layer

Those skilled in the art will recognize improvements and modifications to the preferred embodiments of the present disclosure. All such improvements and modifications are considered within the scope of the concepts disclosed herein and the claims that follow.

What is claimed is:

1. A computer program product for operating a device associated with a user for enabling the sharing of a folder on the device where the folder contains one or more file system objects and includes a folder identification value, the computer program product having a non-transitory computer-readable storage medium having computer program instructions for:
creating a Certificate Authority (CA) for the folder;
granting access to the folder to the user by:
creating a certificate for the user including one or more keys for secure communication between peers, where the peers include any device of any user that has been granted access to the folder;
signing the certificate for the user with a key of the CA for the folder;
creating an Access Control List (ACL) for the user; and
signing the ACL for the user with the key of the CA for the folder; and
sharing the folder with a second device.

2. The computer program product of claim 1 wherein the computer program instructions are further for: creating an ACL for the CA for the folder and signing the ACL for the CA for the folder with the key of the CA for the folder.

3. The computer program product of claim 1 wherein the second device is associated with the user, and sharing the folder with the second device comprises sharing the folder with the second device associated with the user by:
transferring the folder identification value for the folder to the second device associated with the user; and
communicating with one or more peers using the folder identification value to determine the contents of the folder.

4. The computer program product of claim 3 wherein communicating with the one or more peers using the folder identification value to determine the contents of the folder comprises:
connecting with a first peer of the one or more peers using the one or more keys for secure communication between the peers;
determining that a remote file entry object corresponding to a file system object of the one or more file system objects in the folder of the first peer is different than a respective local file entry object corresponding to the file system object in the folder on the device;
in response to determining that the remote file entry object is different than the local file entry object, comparing a timestamp associated with the remote file entry object and a timestamp associated with the local file entry object to determine which is more recently modified;
in response to determining that the remote file entry object is more recently modified, replacing the file system object in the folder with the file system object in the folder of the first peer; and
in response to determining that the local file entry object is more recently modified, replacing the file system object in the folder of the first peer with the file system object in the folder of the device.

5. The computer program product of claim 4 wherein determining that the remote file entry object is different than the local file entry object comprises determining that a hash tree for the folder of the first peer is different than a hash tree for the folder on the device.

6. The computer program product of claim 4 wherein replacing the file system object in the folder with the file system object in the folder of the first peer further comprises determining if the user associated with the first peer has permission to change the file system object.

7. The computer program product of claim 6 wherein determining if the first peer has permission to change the file system object comprises determining if the ACL for a user associated with the change to the file system object permitted the change to the file system object.

8. The computer program product of claim 1 wherein the second device is associated with a second user, and sharing the folder with the second device comprises sharing the folder with the second device associated with the second user by:
transferring the folder identification value for the folder to the second device associated with the second user;
receiving a connection from the second user including the folder identification value and a public key for the second user; and
granting access to the folder to the second user by:
creating a certificate for the second user including one or more keys for secure communication between the peers using the public key for the second user;
signing the certificate for the second user with the key of the CA for the folder;
creating an ACL for the second user; and
signing the ACL for the second user with the key of the CA for the folder; sending the certificate for the second user to the second user.

9. The computer program product of claim 8 wherein the computer program instructions are further for:
updating the ACL for the second user to change the permissions for the second user; and
signing the updated ACL for the second user with the key of the CA for the folder.

10. The computer program product of claim 8 wherein the computer program instructions are further for:
determining that a remote file entry object corresponding to a file system object of the one or more file system objects in the folder of a device associated with the second user is more recently modified than a respective local file entry object corresponding to the file system object in the folder on the device;
determining which ACL for the second user was valid at the time of the modification time of the remote file entry object; and
in response to determining that the ACL for the second user that was valid at the time of the modification time of the remote file entry object permitted the modification, replacing the file system object in the folder with the file system object in the folder of the device associated with the second user.

11. The computer program product of claim 8 wherein the computer program instructions are further for:
creating an intermediate CA using the certificate for the second user;
creating an ACL for the intermediate CA; and
signing the ACL for the intermediate CA with the key of the CA for the folder.

12. The computer program product of claim 8 wherein transferring the folder identification value comprises one of the group consisting of:
displaying the folder identification value to be manually read from the device to be communicated to the second device associated with the second user;
displaying a QR code indicative of the folder identification value on the device to be communicated to the second device associated with the second user; and
copying the folder identification value to a clipboard of the device to be communicated to the second device associated with the second user.

13. The computer program product of claim 1 wherein the folder identification value for the folder is derived from a hash of a certificate of the CA of the folder.

14. The computer program product of claim 1 wherein the one or more file system objects comprises at least one of the group consisting of a file, a directory, and a symlink.

15. A computer program product for operating a second device associated with a second user for sharing a folder on a device associated with a user, the computer program product having a non-transitory computer-readable storage medium having computer program instructions for:
obtaining a folder identification value for the folder;
transmitting to the user the folder identification value and a public key for the second user; and
receiving a certificate for the second user, where the certificate for the second user includes one or more keys for secure communication between peers using the public key for the second user.

16. The computer program product of claim 15, wherein the computer program instructions are further for:
connecting with a first peer using the one or more keys for secure communication between peers;
determining that a remote file entry object corresponding to a file system object of one or more file system objects in the folder of the first peer is different than a respective local file entry object corresponding to the file system object in the folder on the second device;
in response to determining that the remote file entry object is different than the local file entry object, comparing a timestamp associated with the remote file entry object and a timestamp associated with the local file entry object to determine which is more recently modified;
in response to determining that the remote file entry object is more recently modified, replacing the file system object in the folder with the file system object in the folder of the first peer; and
in response to determining that the local file entry object is more recently modified, replacing the file system object in the folder of the first peer with the file system object in the folder of the device.

17. The computer program product of claim 16 wherein replacing the file system object in the folder with the file system object in the folder of the first peer further comprises determining if the user associated with the first peer has permission to change the file system object.

18. The computer program product of claim 17 wherein determining if the first peer has permission to change the file system object comprises determining if an Access Control List (ACL) for the user associated with the change to the file system object permitted the change to the file system object.

19. The computer program product of claim 15 wherein the one or more file system objects comprises at least one of the group consisting of a file, a directory, and a symlink.

20. A method of operating a device associated with a user for enabling the sharing of a folder on the device where the folder contains one or more file system objects and includes a folder identification value, comprising:
creating a Certificate Authority (CA) for the folder;
granting access to the folder to the user by:
creating a certificate for the user including one or more keys for secure communication between peers, where the peers include any device of any user that has been granted access to the folder;
signing the certificate for the user with a key of the CA for the folder;
creating an Access Control List (ACL) for the user; and
signing the ACL for the user with the key of the CA for the folder; and
sharing the folder with a second device.
